(19) United States
(12) Patent Application Publication
(10) Pub. No.: US 2013/0285617 A1
(43) Pub. Date: Oct. 31, 2013

(54) Method for Adjusting a DC Intermediate Circuit Voltage

(71) Applicants: Stefan Butzmann, Beilstein (DE); Holger Fink, Stuttgart (DE)

(72) Inventors: Stefan Butzmann, Beilstein (DE); Holger Fink, Stuttgart (DE)

(73) Assignees: Samsung SDI Co., Ltd., Yongin-si, Gyeonggi-do (KR); Robert Bosch GmbH, Stuttgart (DE)

(21) Appl. No.: 13/825,099

(22) PCT Filed: Aug. 10, 2011
(86) PCT No.: PCT/EP2011/063735

§ 371 Date: Jul. 1, 2013

(30) Foreign Application Priority Data
Sep. 20, 2010 (DE) 102010041016.0

(51) Int. Cl. H02J 7/00

(52) U.S. Cl. CPC H02J 7/0063
USPC 320/135

(57) ABSTRACT

The disclosure relates to a method for adjusting a voltage of a DC intermediate circuit in a battery system composed of a battery and a drive system. The battery is connected to the drive system via the DC intermediate circuit and comprises at least one battery module that has a coupling unit and at least one battery cell connected between a first input and a second input of the coupling unit. In a first method step, the at least one battery cell of the at least one battery module is decoupled during a first variable time period by emitting a corresponding control signal to the coupling unit of the at least one battery module, and the at least one battery module is bridged on the output side so that an output voltage of the battery becomes zero.

The present invention relates to a method for adjusting a DC intermediate circuit voltage and to a battery and to a battery system with a DC intermediate circuit, which battery and battery system are designed to implement the method.

### PRIOR ART

It is apparent that in the future battery systems will be used increasingly both in stationary applications and in vehicles such as hybrid and electric vehicles. In order to be able to meet the requirements in respect of voltage and available power which are provided for a respective application, a high number of battery cells are connected in series. Since the current provided by such a battery needs to flow through all of the battery cells and a battery cell can only conduct a limited current, in addition battery cells are often connected in parallel in order to increase the maximum current. This can take place either by providing a plurality of cell coils within a battery cell housing or by interconnecting battery cells externally.

The basic circuit diagram of a conventional electric drive system as is used, for example, in electric and hybrid vehicles or else in stationary applications such as in the rotor blade adjustment of wind energy installations, is illustrated in FIG. 1. A battery 110 is connected to a DC intermediate circuit, which is formed by a capacitor 111. A pulse-controlled inverter 112 is connected to the DC intermediate circuit and provides sinusoidal voltages which are phase-shifted with respect to one another for the operation of an electric drive motor 113 at three outputs via in each case two switchable semiconductor valves and two diodes. The capacitance of the capacitor 111, which forms the DC intermediate circuit, needs to be high enough to stabilize the voltage in the DC intermediate circuit for a time period in which one of the switchable semiconductor valves is switched on. In a practical application such as an electric vehicle, a high capacitance in the range up to several mF is produced.

FIG. 2 shows the battery 110 in FIG. 1 in a more detailed block circuit diagram. A multiplicity of battery cells are connected in series and optionally additionally in parallel in order to achieve a high output voltage and battery capacity with is desired for a respective application. A charging and isolating device 116 is connected between the positive pole of the battery cells and a positive battery terminal 114. Optionally, an isolating device 117 can additionally be connected between the negative pole of the battery cells and a negative battery terminal 115. The isolating and charging device 116 and the isolating device 117 each comprise a contactor 118 and 119, respectively, which are provided for isolating the battery cells from the battery terminals in order to switch the battery terminals to be free of voltage. Owing to the high DC voltage of the series-connected battery cells, there is otherwise a considerable potential hazard for maintenance personnel or the like. In the charging and isolating device 116, in addition a charging contactor 120 with a charging resistor 121, which is connected in series with the charging contactor 120, is provided. The charging resistor 121 limits a charging current for the capacitor 111 when the battery is connected to the DC intermediate circuit. For this purpose, first the contactor 118 is left open and only the charging contactor 120 is closed. If the voltage at the positive battery terminal 114 reaches the voltage of the battery cells, the contactor 119 can be closed and possibly the charging contactor 120 can be opened.

In applications which have a power in the region of a few 10 kW, the charging contactor 120 and the charging resistor 121 represent significant additional complexity which is only required for the charging operation of the DC intermediate circuit which lasts several hundred milliseconds. Said components are not only expensive but are also large and heavy, which is particularly disruptive for use in mobile applications such as electric motor vehicles.

### DISCLOSURE OF THE INVENTION

Therefore, the invention introduces a method for adjusting a voltage of a DC intermediate circuit in a battery system with a battery and a drive system. In this case, the battery is connected to the drive system via the DC intermediate circuit and has at least one battery module, which comprises a coupling unit, and at least one battery cell, which is connected between a first input and a second input of the coupling unit, the method having at least the following steps:
a) during a first variable timespan, decoupling the battery cells of the at least one battery module by outputting a corresponding control signal to the coupling unit of the at least one battery module and bridging, on the output side, the at least one battery module, with the result that an output voltage of the battery becomes zero;
b) during a second variable timespan, coupling the battery cells of the at least one battery module and ending the bridging, on the output side, of the at least one battery module by ending the output of the corresponding control signal to the coupling unit of the at least one battery module, with the result that a magnitude of the output voltage of the battery becomes greater than zero; and
c) repeating steps a) and b) until a voltage of the DC intermediate circuit reaches a setpoint operating voltage.

The method of the invention provides the advantage that the output voltage of the battery is switched over between zero and the output voltage of the at least one battery module quickly and in controlled fashion, as a result of which, on average over time, an adjustable charging current for the DC intermediate circuit results. Since the charging current can be adjusted and therefore also limited to a desired value by selecting suitable first and second variable timespans, the charging contactor 120 and the charging resistor 121 of the battery systems from the prior art can be dispensed with, by virtue of which costs, volume and weight of a battery system operating in accordance with the method according to the invention can be correspondingly reduced.

In addition, the method of the invention has the advantage that the DC intermediate circuit is charged in a shorter period of time. In a battery system with the battery shown in FIG. 2 with the charging and isolating device 116, the DC intermediate circuit is charged up to closing of the contactor 118 with a characteristic which corresponds to an exponential function with a negative exponent. This means that, at the beginning of the charging operation, the maximum charging current is flowing, but this charging current decreases increasingly as the charging of the DC intermediate circuit continues, with the result that the voltage of the DC intermediate circuit asymptotically approximates the value of the output voltage of the battery. In accordance with the method of the invention, however, the voltage of the DC intermediate circuit can be increased linearly and the capacitance of the DC intermediate circuit can thus be charged with an on average constant current over the entire charging time period, which constant current has at least a similar value to the initial charging current in a battery system with a charging resistor 121. As a result, the first setpoint operating voltage is reached correspondingly more quickly.

Preferably, the setpoint operating voltage is equal to a maximum output voltage of the battery. In this case, the method is implemented until the DC intermediate circuit has reached the maximum possible voltage. Then, the closed-loop control system can be deactivated, with the result that the voltage of the DC intermediate circuit is coupled directly to the output voltage of the battery.

Preferably, the method has an additional step of measuring the voltage of the DC intermediate circuit. As a result, it is possible to implement not only open-loop control methods but also closed-loop control methods, in which the closed-loop control is implemented depending on the measured values of the target measured variable, i.e. the voltage of the DC intermediate circuit.

The first variable timespan and the second variable timespan are particularly preferably determined depending on a difference between the setpoint operating voltage and the voltage of the DC intermediate circuit. The (average) current which is set during the second variable timespan is also dependent on the difference between the present voltage of the DC intermediate circuit and the setpoint operating voltage (usually equal to the maximum output voltage of the battery), in addition to being dependent on the ratio of the first variable timespan to the second variable timespan. In order to adjust, for example, a charging current which is on average constant throughout the charging operation of the DC intermediate circuit, the first variable timespan is shortened in relation to the second variable timespan, for example, the lower the difference is. Alternatively or in addition, it is naturally also possible for the second variable timespan to be extended in relation to the first variable timespan.

The method can have an additional step of measuring a present charging current. As a result, a closed-loop control method used can also take into consideration the charging current flowing at that time or it is possible for safety mechanisms for protecting against impermissibly high charging currents to be implemented.

Particularly preferably, the method therefore also has an additional step of comparing the measured present charging current with a maximum permissible charging current, wherein step b) is ended when the present charging current is greater than the maximum permissible charging current.

As a continuation of the two last-mentioned variant configurations, the method can also have an additional step of determining an average charging current and comparing the average charging current with a setpoint charging current, wherein the first variable timespan is extended and/or the second variable timespan is shortened when the average charging current is greater than the setpoint charging current and/or wherein the first variable timespan is shortened and/or the second variable timespan is extended when the average charging current is less than the setpoint charging current.

Particularly preferably, a setpoint charging current is adjusted constantly until the voltage of the DC intermediate circuit reaches the setpoint operating voltage. In this way, the voltage of the DC intermediate circuit will increase linearly and the DC circuit will be charged in a very short period of time without a maximum permissible charging current being exceeded.

A second aspect of the invention introduces a battery with a control unit and at least one battery module. The at least one battery module in this case comprises a coupling unit and at least one battery cell, which is connected between a first input and a second input of the coupling unit. According to the invention, the control unit is designed to implement the method of the first aspect according to the invention.

Particularly preferably, in this case the battery cells of the battery modules are lithium-ion battery cells. Lithium-ion battery cells have the advantages of a high cell voltage and a high energy content in a given volume.

A further aspect of the invention relates to a battery system with a battery, a DC intermediate circuit connected to the battery and a drive system connected to the DC intermediate circuit. In this case, the battery is designed in accordance with the preceding aspect of the invention.

Particularly preferably, the DC intermediate circuit is in this case connected directly to the battery, i.e. no further components are provided between the battery and the DC intermediate circuit, in particular no charging device or no charging contactor and no charging resistor. In embodiments of the battery system, however, further components such as current sensors can also be connected between the battery and the DC intermediate circuit.

The DC intermediate circuit can have a capacitor or comprise a capacitor.

The battery system can be implemented in a motor vehicle, for example, wherein the drive system comprises an electric drive motor for driving the motor vehicle and a pulse-controlled inverter.

### DRAWINGS

Exemplary embodiments of the invention will be explained in more detail with reference to the drawings and the description below, wherein identical reference symbols denote identical or functionally identical components. In the drawings:

FIG. 1 shows an electric drive system in accordance with the prior art,

FIG. 2 shows a block circuit diagram of a battery in accordance with the prior art,

FIG. 3 shows a first embodiment of a coupling unit of use in a battery which can be used to implement the method according to the invention,

FIG. 4 shows a possible modification in terms of circuitry of the first embodiment of the coupling unit,

FIGS. 5 and 6 show two embodiments of a battery module with the first embodiment of the coupling unit,

FIG. 7 shows a second embodiment of a coupling unit for use in a battery which can be used to implement the method according to the invention,

FIG. 8 shows a possible modification in terms of circuitry of the second embodiment of the coupling unit,

FIG. 9 shows an embodiment of a battery module with the second embodiment of the coupling unit,

FIG. 10 shows a battery which can be used to implement the method according to the invention, and

FIG. 11 shows a block diagram of an exemplary closed-loop control system in accordance with the invention.

### EMBODIMENTS OF THE INVENTION

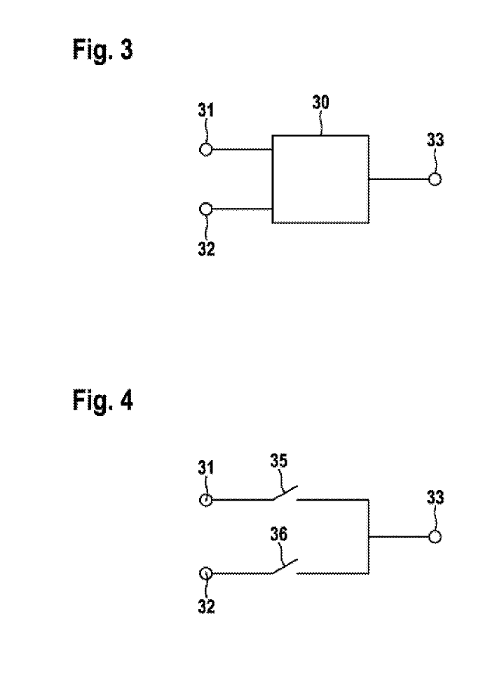

FIG. 3 shows a first embodiment of a coupling unit 30 for use in a battery which can be used to implement the method according to the invention. The coupling unit 30 has two inputs 31 and 32 and an output 33 and is designed to connect one of the inputs 31 or 32 to the output 33 and to decouple the other of the inputs.

FIG. 4 shows a possible modification in terms of circuitry of the first embodiment of the coupling unit 30, in which a first and a second switch 35 and 36, respectively, are provided. Each of the switches 35, 36 is connected between one of the inputs 31 or 32 and the output 33. This embodiment provides the advantage of it also being possible for both inputs 31, 32 to be decoupled from the output 33, with the result that the output 33 becomes highly resistive, which can be useful in the case of repair or maintenance, for example. In addition, the switches 35, 36 can simply be implemented as semiconductor switches, such as MOSFETs or IGBTs, for example. Semiconductor switches have the advantages of a favorable price and a high switching speed, with the result that the coupling unit 30 can respond to a control signal or to a change in the control signal within a short period of time.

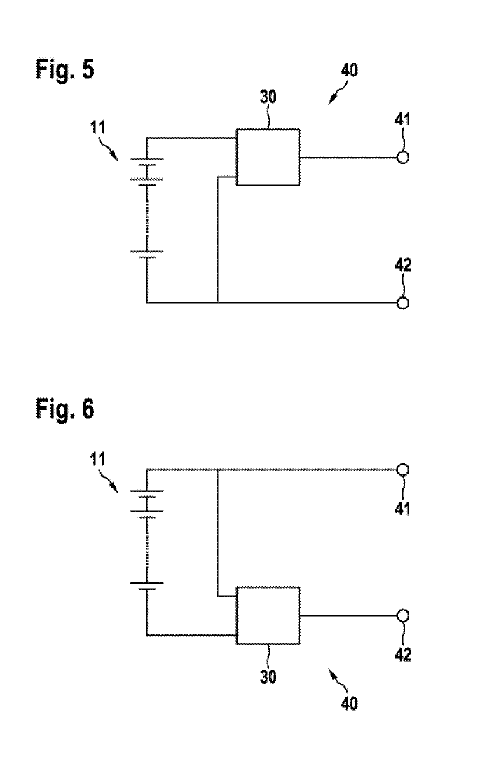

FIGS. 5 and 6 show two embodiments of a battery module 40 with the first embodiment of the coupling unit 30. A plurality of battery cells 11 is connected in series between the inputs of the coupling unit 30. However, the invention is not restricted to such a series circuit of battery cells 11; it is also possible for only a single battery cell 11 to be provided or else for a parallel circuit or a mixed series/parallel circuit of battery cells 11 to be provided. In the example shown in FIG. 5, the output of the coupling unit 30 is connected to a first terminal 41 and the negative pole of the battery cells 11 is connected to a second terminal 42. However, an almost mirror-image arrangement to that shown in FIG. 6 is possible, in which the positive pole of the battery cells 11 is connected to the first terminal 41 and the output of the coupling unit 30 is connected to the second terminal 42.

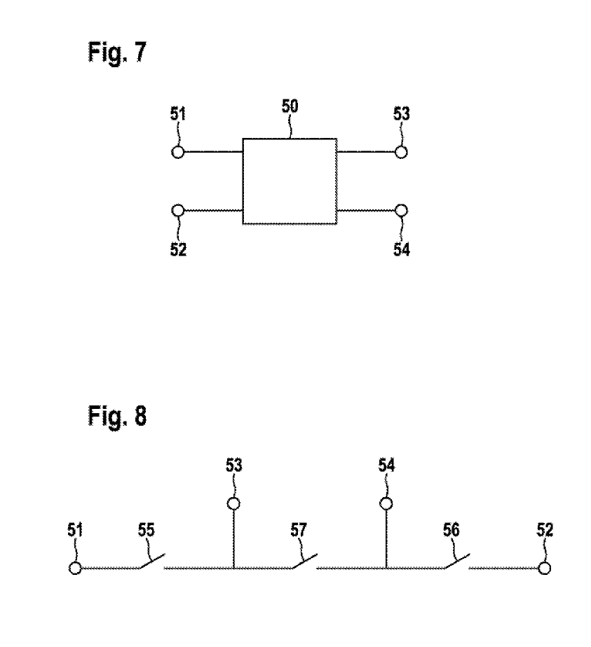

FIG. 7 shows a second embodiment of a coupling unit 50 for use in a battery which can be used to implement the method according to the invention. The coupling unit 50 has two inputs 51 and 52 and two outputs 53 and 54. Said coupling unit is designed to connect either the first input 51 to the first output 53 and the second input 52 to the second output 54 (and to decouple the first output 53 from the second output 54) or else to connect the first output 53 to the second output 54 (and in this case decouple the inputs 51 and 52). In specific embodiments of the coupling unit 50, said coupling unit can also be designed to isolate both inputs 51, 52 from the outputs 53, 54 and also to decouple the first output 53 from the second output 54. However, no provision is made for both the first input 51 to be connected to the second input 52.

FIG. 8 shows a possible modification in terms of circuitry of the second embodiment of the coupling unit 50, in which a first, a second and a third switch 55, 56 and 57 are provided. The first switch 55 is connected between the first input 51 and the first output 53, the second switch 56 is connected between the second input 52 and the second output 54, and the third switch 57 is connected between the first output 53 and the second output 54. This embodiment likewise provides the advantage that the switches 55, and 57 can easily be implemented in the form of semiconductor switches, such as MOSFETs or IGBTs, for example. Semiconductor switches have the advantages of a favorable price and a high switching speed, with the result that the coupling unit 50 can respond to a control signal or to a change in the control signal within a short period of time.

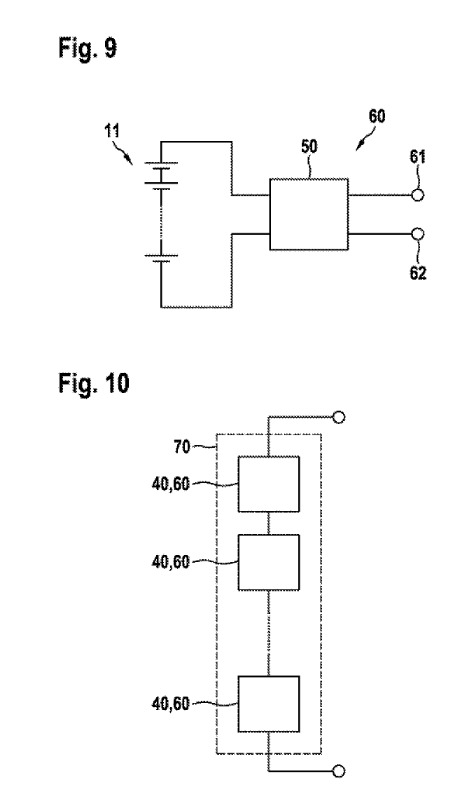

FIG. 9 shows a embodiment of a battery module 60 with the second embodiment of the coupling module 50. A plurality of battery cells 11 is connected in series between the inputs of a coupling unit 50. This embodiment of the battery module 60 is not restricted to such a series circuit of battery cells 11 either; it is again also possible for only a single battery cell 11 to be provided or else a parallel circuit or mixed series/parallel circuit of battery cells 11. The first output of the coupling unit 50 is connected to a first terminal 61 and the second output of the coupling unit 40 is connected to a second terminal 62. The battery module 60 provides the advantage over the battery module 40 in FIGS. 5 and 6 that the battery cells 11 can be decoupled from the rest of the battery on both sides by the coupling unit 50, which enables hazard-free replacement during running operation since the hazardous high total voltage of the remaining battery modules in the battery is not present at any pole of the battery cells 11.

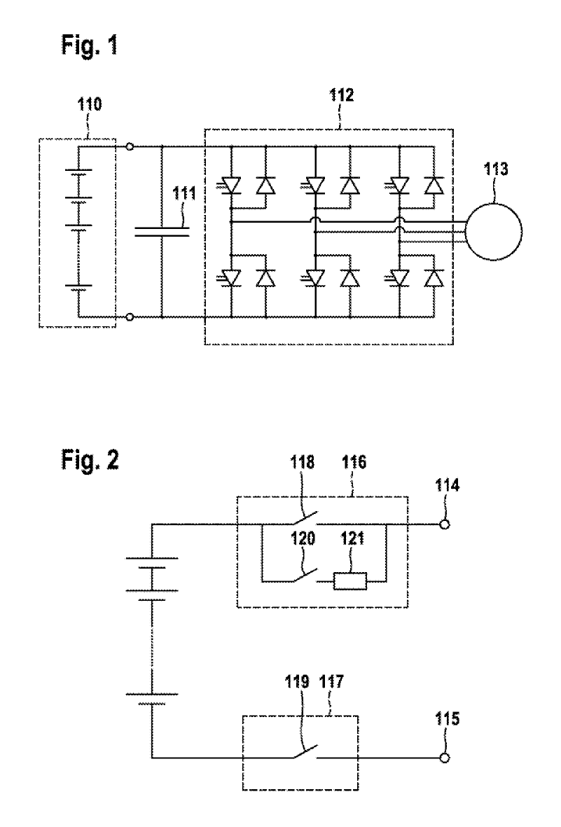

FIG. 10 shows an embodiment of a battery which can be used to implement the method according to the invention. The battery has a battery module string 70 with a plurality of battery modules 40 or 60, wherein preferably each battery module 40 or 60 contains the same number of battery cells 11, interconnected identically. In general, the battery module string 70 can contain any number of battery modules 40 or 60 greater than 1. In addition, charging and isolating devices and isolating devices as in FIG. 2 can also be provided at the poles of the battery module string 70 when safety regulations dictate this. However, such isolating devices are not necessary according to the invention because decoupling of the battery cells 11 from the battery terminals can take place by the coupling units 30 or 50 contained in the battery modules 40 or 60.

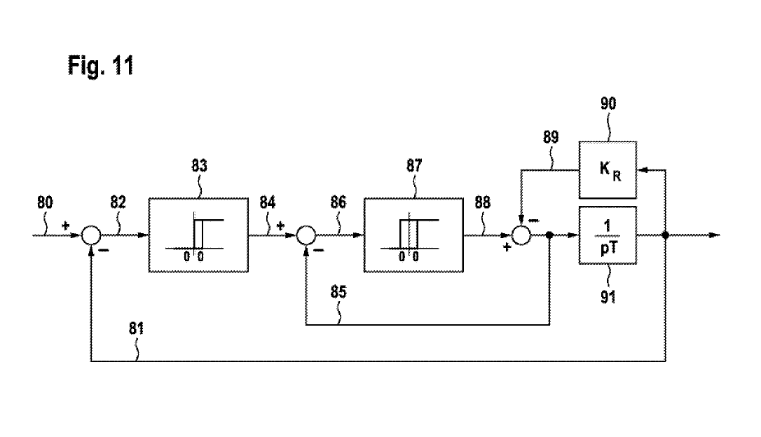

FIG. 11 shows a block diagram of an exemplary closed-loop control system in accordance with the invention. On the input side, a setpoint operating voltage for the DC intermediate circuit is provided at the point 80, which setpoint operating voltage is compared with an actual operating voltage of the DC intermediate circuit at the point 81 by a subtractor and provides a voltage difference at the point 82. The voltage difference is subjected to a quantization operation in a closed-loop control element 83, which quantization operation implements the desired two-step closed-loop control by virtue of the voltage difference at the point 82 being converted into a setpoint charging current at the point 84, which can only assume two different values. Optionally, the closed-loop control element 83 can also implement a hysteresis function, which advantageously reduces the switching frequency of the closed-loop control system.

At the point 85 an actual charging current is subtracted in a following subtractor from the setpoint charging current at the point 84, with the result that a manipulated variable for the current is present at the point 86, which manipulated variable is converted in a following closed-loop control element 87 at the point 88 into a discretized current value for the selection of an output voltage of the battery. The closed-loop control element 87 can likewise optionally be equipped with a hysteresis function in order to reduce the switching frequency of the closed-loop control.

The downstream blocks model the response of the DC intermediate circuit. The voltage of the DC intermediate circuit at the point 81 is converted via a proportional element 90 with a scalar factor K_{R} into a current value at the point 89 which is subtracted in a further subtractor from the discretized current value at the point 88 and thus produces the actual current value at the point 85. The actual current value can also be determined by direct measurement and averaging over a suitable timespan and enter the closed-loop control system at the point 85. The closed-loop control element 91 describes the integrator property of a capacitance, namely how it at least approximately represents the DC intermediate circuit, and converts the current flowing into the DC intermediate circuit into the voltage of the DC intermediate circuit. It is also true here that, in practice, the actual voltage of the DC intermediate circuit is not usually calculated, but determined by measurement.

Alternatively, the closed-loop control system can also be implemented as a two-point closed-loop control with a minimum residence time in the two switching states, as a result of which the switching frequency of the actuating element is likewise limited. Preferably, the switching state change is performed in time-discrete fashion, i.e. synchronously with a clock of 100 kHz, for example, which would result in a maximum switching frequency of 50 kHz.

The invention is based on the concept that a battery with a coupling unit for adjusting the output voltage of the battery can be used directly as a two-point actuating element for the charging operation of the DC intermediate circuit. This can be realized without considerable additional complexity with software functions as part of the open-loop control of the battery. In order to incorporate this two-point actuating element in a control loop, there is a wide variety of known two-point methods with their respective advantages and disadvantages. These methods differ substantially in terms of the maximum switching frequency and in terms of the AC components which the charging current has during the charging operation. The control loop shown in FIG. 11 is merely an example of a possible two-point method.

The invention makes it possible to adjust the voltage of a DC intermediate circuit in a controlled manner without a charger. As a result, the charger usually provided in a practical application can be dispensed with, which saves on costs and reduces volume and weight of the overall arrangement.

1. A method for adjusting a voltage of a DC intermediate circuit in a battery system including a battery and a drive system, wherein the battery is connected to the drive system via the DC intermediate circuit and includes at least one battery module, wherein the at least one battery module comprises a coupling unit and at least one battery cell, and wherein the at least one battery cell is connected between a first input and a second input of the coupling unit, the method comprising:
a) during a first variable timespan, decoupling the at least one battery cell of the at least one battery module by outputting a corresponding control signal to the coupling unit of the at least one battery module and bridging, on the output side, the at least one battery module, with the result that an output voltage of the battery becomes zero;
b) during a second variable timespan, coupling the at least one battery cell of the at least one battery module and ending the bridging, on the output side, of the at least one battery module by ending the output of the corresponding control signal to the coupling unit of the at least one battery module, with the result that a magnitude of the output voltage of the battery becomes greater than zero; and
c) repeating steps a) and b) until a voltage of the DC intermediate circuit reaches a setpoint operating voltage.

2. The method as claimed in claim 1, wherein the setpoint operating voltage is equal to a maximum output voltage of the battery.

3. The method as claimed in claim 1, further comprising:
measuring the voltage of the DC intermediate circuit.

4. The method as claimed in claim 3, wherein the first variable timespan and the second variable timespan are determined depending on a difference between the setpoint operating voltage and the voltage of the DC intermediate circuit.

5. The method as claimed in claim 1, further comprising:
measuring a present charging current.

6. The method as claimed in claim 5, further comprising:
comparing the measured present charging current with a maximum permissible charging current,
wherein step b) is ended when the present charging current is greater than the maximum permissible charging current.

7. The method as claimed in claim 5, further comprising:
determining an average charging current and
comparing the average charging current with a setpoint charging current,
wherein the first variable timespan is extended and/or the second variable timespan is shortened if the average charging current is greater than the setpoint charging current, and
wherein the first variable timespan is shortened and/or the second variable timespan is extended when the average charging current is lower than the setpoint charging current.

8. The method as claimed in claim 7, wherein the setpoint charging current is adjusted constantly until the voltage of the DC intermediate circuit reaches the setpoint operating voltage.

9. A battery comprising:
a control unit and
at least one battery module including a coupling unit and at least one battery cell,
wherein the at least one battery cell is connected between a first input and a second input of the coupling unit,
wherein the control unit is configured to implement a method for adjusting a voltage of a DC intermediate circuit in a battery system,
wherein the DC intermediate circuit is configured to connect the battery to a drive system,
wherein the method includes
a) during a first variable timespan, decoupling the at least one battery cell of the at least one battery module by outputting a corresponding control signal to the coupling unit of the at least one battery module and bridging, on the output side, the at least one battery module, with the result that an output voltage of the battery becomes zero,
b) during a second variable timespan, coupling the at least one battery cell of the at least one battery module and ending the bridging, on the output side, of the at least one battery module by ending the output of the corresponding control signal to the coupling unit of the at least one battery module, with the result that a magnitude of the output voltage of the battery becomes greater than zero, and
c) repeating steps a) and b) until a voltage of the DC intermediate circuit reaches a setpoint operating voltage.

10. A battery system comprising:
a battery including a control unit and at least one battery module including a coupling unit and at least one battery cell;
a DC intermediate circuit connected to the battery; and
a drive system connected to the DC intermediate circuit,
wherein the at least one battery cell is connected between a first input and a second input of the coupling unit,
wherein the control unit is configured to implement a method for adjusting a voltage of the DC intermediate circuit,
wherein the method includes
a) during a first variable timespan, decoupling the at least one battery cell of the at least one battery module by outputting a corresponding control signal to the coupling unit of the at least one battery module and bridging, on the output side, the at least one battery module, with the result that an output voltage of the battery becomes zero,
b) during a second variable timespan, coupling the at least one battery cell of the at least one battery module and ending the bridging, on the output side, of the at least one battery module by ending the output of the corresponding control signal to the coupling unit of the at least one battery module, with the result that a magnitude of the output voltage of the battery becomes greater than zero, and
c) repeating steps a) and b) until a voltage of the DC intermediate circuit reaches a setpoint operating voltage.
